(19) United States
(12) Patent Application Publication
(10) Pub. No.: US 2002/0116178 A1
(43) Pub. Date: Aug. 22, 2002

(54) High quality time-scaling and pitch-scaling of audio signals

(76) Inventor: Brett G. Crockett, Brisbane, CA (US)

Correspondence Address: GALLAGHER & LATHROP, 601 CALIFORNIA ST, SUITE 1111, SAN FRANCISCO, CA, 94108, US

(21) Appl. No.: 09/922,394

(22) Filed: Aug. 2, 2001

Related U.S. Application Data
(63) Continuation of application No. 09/834,739, filed on Apr. 13, 2001.

(51) Int. Cl. G10L 19/00; G06F 17/00

(52) U.S. Cl. 704/200.1

(57) ABSTRACT

A method for time scaling and/or pitch shifting an audio signal analyzes an audio signal using multiple psychoacoustic criteria to identify a region of the audio signal in which the omission of a portion of the audio signal or the repetition of a portion of the audio signal is inaudible or minimally audible, it selects a splice point in the region of the audio signal, it deletes a portion of the audio signal beginning at the splice point or it repeats a portion of the audio signal ending at the splice point, and it reads out the resulting audio signal at a rate that yields a desired audio signal time duration and a desired time scaling and/or pitch shifting. In another aspect, a method for time scaling and/or pitch shifting multiple channels of audio signals analyzes each of the audio signals using at least one psychoacoustic criterion to identify at least one region in each of the audio signals in which the omission of a portion of the audio signal or the repetition of a portion of the audio signal is inaudible or minimally audible, it selects a common splice point in one of the regions in each of the audio signals, wherein the splice points in the multiple channels of audio signals are selected to be substantially aligned with one another, it deletes a portion of each audio signal beginning at the common splice point or it repeats a portion of the audio signal ending at the common splice point, and it reads out the joined leading and trailing segments at a rate that yields a desired audio signal time duration and a desired time scaling and/or pitch shifting.

### AUTHORIZATION WITH RESPECT TO COPYRIGHTS

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

1. Field of the Invention

The present invention pertains to the field of psychoacoustic processing of audio signals. In particular, the invention relates to aspects of time scaling and/or pitch scaling (pitch shifting) of audio signals. The processing is particularly applicable to audio signals represented by samples, such as digital audio signals.

2. Background of the Invention

Time scaling refers to altering the playback rate (time evolution or duration) of an audio signal while not altering the spectral content or perceived pitch of the signal (where pitch is a characteristic associated with periodic audio signals). Pitch scaling refers to modifying the pitch (spectral content) of an audio signal while not affecting its rate of playback, and most importantly, not affecting the audio signal's time evolution or duration. Time scaling and pitch scaling are dual methods of one another. For example, a digitized audio signal's pitch may be scaled up by 5% by increasing the time duration of the signal by time scaling it by 5% and then resampling the signal at a 5% higher sample rate. The resulting signal has the same time duration as the original signal but with modified pitch or spectral characteristics. As discussed farther below, resampling is not an essential step unless it is desired to maintain a constant output sampling rate or to maintain the input and output sampling rates the same.

There are many uses for a high quality method that provides independent control of the time and pitch characteristics of an audio signal. This is particularly true for high fidelity, multichannel audio that may contain wide ranging content from simple tone signals to voice signals and complex musical passages. Uses for time and pitch scaling include audio/video broadcast, audio/video postproduction synchronization and multi-track audio recording and mixing. In the audio/video broadcast and post production environment it may be necessary to play back the video at a different rate than the source material was recorded which would result in a pitch-scaled version of the accompanying audio signal. Pitch scaling the audio maintains synchronization between the audio and video while preserving the pitch of the original source material. In multi-track audio or audio/video postproduction, it may be required for new material to match the time-constrained duration of an audio or video piece. Time-scaling the audio can time-constrain the new piece of audio without modifying the pitch of the source audio.

### SUMMARY OF THE INVENTION

In accordance with an aspect of the present invention a method for time scaling and/or pitch shifting an audio signal analyzes an audio signal using multiple psychoacoustic criteria to identify a region of the audio signal in which the omission of a portion of the audio signal or the repetition of a portion of the audio signal is inaudible or minimally audible, it selects a splice point in the region of the audio signal, it deletes a portion of the audio signal beginning at the splice point or it repeats a portion of the audio signal ending at the splice point, and it reads out the resulting audio signal at a rate that yields a desired audio signal time duration and a desired time scaling and/or pitch shifting. In another aspect, a method for time scaling and/or pitch shifting multiple channels of audio signals analyzes each of the audio signals using at least one psychoacoustic criterion to identify at least one region in each of the audio signals in which the omission of a portion of the audio signal or the repetition of a portion of the audio signal is inaudible or minimally audible, it selects a common splice point in one of the regions in each of the audio signals, wherein the splice points in the multiple channels of audio signals are selected to be substantially aligned with one another, it deletes a portion of each audio signal beginning at the common splice point or it repeats a portion of the audio signal ending at the common splice point, and it reads out the joined leading and trailing segments at a rate that yields a desired audio signal time duration and a desired time scaling and/or pitch shifting.

In accordance with a further aspect of the present invention, a method is provided for time scaling and/or pitch shifting an audio signal represented by samples. The audio signal is analyzed using multiple psychoacoustic criteria to identify a region of the audio signal in which the omission of a portion of the audio signal or the repetition of a portion of the audio signal is inaudible or minimally audible. A splice point in that region of the audio signal is selected, thereby defining a leading segment of the audio signal, having sample numbers lower than the splice point, which leads the splice point. An end point spaced from the splice point is selected, thereby defining a trailing segment of the audio signal, having sample numbers higher than the splice point, which trails the endpoint, and a target segment of the audio signal between the splice and end points. The leading and trailing segments at the splice point are joined, thereby decreasing the number of audio signal samples by omitting the target segment when the end point has a higher sample number than the splice point, or increasing the number of samples by repeating the target segment when the end point has a lower sample number than the splice point. The joined leading and trailing segments are read out at a rate that yields a desired audio signal time duration and a desired time scaling and/or pitch shifting. For example, (1) a time duration the same as the original time duration results in pitch shifting the audio signal, (2) a time duration decreased by the same proportion as the relative change in the reduction in the number of samples, in the case of omitting the target segment, results in time compressing the audio signal, (3) a time duration increased by the same proportion as the relative change in the increase in the number of samples, in the case of repeating the target segment, results in time expanding the audio signal, (4) a time duration decreased by a proportion different from the relative change in the reduction in the number of samples results in time compressing and pitch shifting the audio signal, and (5) a time duration increased by a proportion different from the relative change in the increase in the number of samples results in time expansion and pitch shifting the audio signal.

Throughout this document, an audio “region”, “segment”, and “portion” each refer to a representation of a finite continuous portion of the audio stream from a single channel that is conceptually between any two moments in time. Such a region, segment, or portion may be represented by samples having consecutive sample numbers. “Identified region” refers to a region, segment or portion of audio identified by psychoacoustic criteria and within which the splice point, and sometimes the end point, will lie. According to a further aspect of the invention, the end point is also selected to be in the identified region. “Processing region” refers to a region, segment or portion of audio over which correlation will be performed in the search for an end point. “Psychoacoustic criteria” may include criteria based on both time domain and frequency domain masking. As noted above, the “target segment” is that portion of audio that is removed, in the case of compression, or repeated, in the case of expansion.

According to yet a further aspect of the invention, analyzing the audio signal using multiple psychoacoustic criteria includes analyzing the audio signal to identify a region of the audio signal in which the audio satisfies at least one criterion of a group of psychoacoustic criteria.

According to still yet a further aspect of the invention, the psychoacoustic criteria include one or more of the following: (1) the identified region of the audio signal is substantially premasked or postmasked as the result of a transient, (2) the identified region of the audio signal is substantially inaudible, (3) the identified region of the audio signal is predominantly at high frequencies, and (4) the identified region of the audio is a quieter portion of a segment of the audio signal in which a portion or portions of the segment preceding and/or following the region is louder.

An aspect of the invention is that the group of psychoacoustic criteria may be arranged in a descending order of the increasing audibility of artifacts (i.e., a hierarchy of criteria) resulting from the joining of the leading and trailing segments at the splice point.

According to another aspect of the invention, a region is identified when the highest-ranking psychoacoustic criterion (i.e., the criterion leading to the least audible artifacts of the group of criteria) is satisfied. Alternatively, even if a criterion is satisfied, other criteria may be searched for in order to identify one or more other regions in the signal stream that satisfy a criterion. The latter approach may be useful in the case of multichannel audio in order to know the position of all possible regions satisfying any of the criteria, including those further down the hierarchy, so that there are more possible common splice points among the multiple channels.

Whether a target segment is omitted (data compression) or repeated (data expansion), there is only one splice point and one splice. In the case of omitting the target segment, the splice is where the splice point and end point of the omitted target segment are joined together or spliced. In the case of repeating, a target segment there is still only a single splice—the splice is where the end of the first rendition of the target segment (the splice point) meets the start of the second rendition of the target segment (the end point). Depending on the nature of the criterion that renders the identified region inaudible or minimally audible, it may be desirable that the end point is within the identified region (in addition to the splice point, which should always be within the identified region). In the case of increasing the number of audio samples (data expansion), the end point in the original audio preferably is also within the identified region of the audio signal. As described below, when the audio is represented by samples within a buffer memory, the splice point has minimum and maximum locations within the buffer.

Aspects of the present invention take advantage of human hearing and in particular the psychoacoustic phenomenon known as masking. The solid line 10 in FIG. 1 shows the sound pressure level at which sound, such as a sine wave or a narrow band of noise, is just audible, that is, the threshold of hearing. Sounds at levels above the curve are audible; those below it are not. This threshold is clearly very dependent on frequency. One is able to hear a much softer sound at say 4 kHz than at 50 Hz or 15 kHz. At 25 kHz, the threshold is off the scale: no matter how loud it is, one cannot hear it.

Consider the threshold in the presence of a relatively loud signal at one frequency, say a 500 Hz sine wave at 12. The modified threshold 14 rises dramatically in the immediate neighborhood of 500 Hz, modestly somewhat further away in frequency, and not at all at remote parts of the audible range.

This rise in the threshold is called masking. In the presence of the loud 500 Hz sine wave signal (the “masking signal” or “masker”), signals under this threshold, which may be referred to as the “masking threshold”, are hidden, or masked, by the loud signal. Further away, other signals can rise somewhat in level above the no-signal threshold, yet still be below the new masked threshold and thus be inaudible. However, in remote parts of the spectrum in which the no-signal threshold is unchanged, any sound that was audible without the 500 Hz masker will remain just as audible with it. Thus, masking is not dependent upon the mere presence of one or more masking signals; it depends upon where they are spectrally. Some musical passages, for example, contain many spectral components distributed across the audible frequency range, and therefore give a masked threshold curve that is raised everywhere relative to the no-signal threshold curve. Other musical passages, for example, consist of relatively loud sounds from a solo instrument having spectral components confined to a small part of the spectrum, thus giving a masked curve more like the sine wave masker example of FIG. 1.

Masking also has a temporal aspect that depends on the time relationship between the masker(s) and the masked signal(s). Some masking signals provide masking essentially only while the masking signal is present (“simultaneous masking”). Other masking signals provide masking not only while the masker occurs but also earlier in time (“backward masking” or “premasking”) and later in time (“forward masking” or “postmasking”). A “transient”, a sudden, brief and significant increase in signal level, may exhibit all three “types” of masking: backward masking, simultaneous masking, and forward masking, whereas, a steady state or quasi-steady-state signal may exhibit only simultaneous masking. In the context of the present invention, advantage should not be taken of the simultaneous masking resulting from a transient because it is undesirable to disturb a transient by placing a splice coincident or nearly coincident with it.

Audio transient data has long been known to provide both forward and backward temporal masking. Transient audio material “masks” audible material both before and after the transient such that the audio directly preceding and following is not perceptible to a listener (simultaneous masking by a transient is not employed to avoid repeating or disrupting the transient). Pre-masking has been measured and is relatively short and lasts only a few msec while postmasking can last longer than 100 msec. Both pre- and post-transient masking may be exploited although postmasking is generally more useful because of its longer duration.

One aspect of the present invention is transient detection in which sub-blocks (portions of a block of audio samples) are examined. A measure of their magnitudes is compared to a smoothed moving average representing the magnitude of the signal up to that point. The operation may be performed separately for the whole audio spectrum and for high frequencies only, to ensure that high frequency transients are not diluted by the presence of larger lower frequency signals and, hence, missed. Alternatively, any suitable known way to detect transients may be employed.

A splice creates a disturbance that results in artifacts having spectral components that decay with time. The spectrum of the splicing artifacts depends on: (1) the spectra of the signals being spliced (as discussed further below, it is recognized that the artifacts potentially have a spectrum different from the signals being spliced), (2) the extent to which the waveforms match when joined together at the splice point (avoidance of discontinuities), and (3) the shape and duration of the crossfade where the waveforms are joined together at the splice point. Crossfading in accordance with aspects of the invention is described further below. Correlation techniques to assist in matching the waveforms where joined are also described below. According to an aspect of the present invention, it is desirable for the artifacts to be masked, inaudible or minimally audible. The psychoacoustic criteria contemplated by the present invention include criteria that result in the artifacts being masked, inaudible or minimally audible. Inaudibility or minimal audibility may be considered as types of masking. Masking requires that the artifacts be constrained in time and frequency so as to be below the masking threshold of the masking signal(s) (or, in the absence of a masking signal(s), below the no-signal threshold of audibility, which may be considered a form of masking). The duration of the artifacts is well defined, being, to a first approximation, essentially the length (time duration) of the crossfade (the crossfade window). The slower the crossfade, the narrower the spectrum of the artifacts but the longer their duration.

Some general principles as to rendering a splice inaudible or minimally audible may be appreciated by considering a continuum of rising signal levels. Consider the case of splicing low-level signals that provide little or no masking. A well-performed splice (i.e., well-matched waveforms with minimal discontinuity) will introduce artifacts somewhat lower in amplitude, probably below the hearing threshold, so no masking signal is required. As the levels are raised, the signals begin to act as masking signals, raising the hearing threshold. The artifacts also increase in magnitude, so that they are above the no-signal threshold, except that the threshold has also been raised (as discussed above in connection with FIG. 1).

Ideally, in accordance with an aspect of the present invention, for a transient to mask the artifacts, the artifacts occur in the backward masking or forward masking temporal region of the transient and every artifact spectral component is below the masking threshold of the transient at every instant in time. In practical implementations, not all spectral components of the artifacts may be masked at all instants of time.

Ideally, in accordance with another aspect of the present invention, for a steady state or quasi-steady-state signal to mask the artifacts, the artifacts occur at the same time as the masking signal and every spectral component is below the masking threshold of the steady-state signal at every instant in time. In practical implementations, not all spectral components of the artifacts may be masked at all instants of time.

There is a further possibility in accordance with yet another aspect of the present invention, which is that the spectral components of the artifacts are below the no-signal threshold of human audibility. In this case, there need not be any masking signal although such inaudibility may be considered to be a masking of the artifacts.

In principle, with sufficient processing power and/or processing time, it is possible to forecast the time and spectral characteristics of the artifacts based on the signals being spliced in order to determine if the artifacts will be masked or inaudible. However, to save processing power and time, useful results may be obtained simply by considering the magnitude of the signals being spliced in the vicinity of the splice point (particularly within the crossfade window that contains the splice point), or, in the case of a steady-state or quasi-steady-state predominantly high frequency identified region in the signal, merely by considering the frequency content of the signals being spliced without regard to magnitude.

If the splice point is within a region of the audio signal identified as below the threshold of human audibility, then the resulting components of the artifacts will be below the threshold of human audibility if each of the magnitudes at the splice point is below a fixed threshold, invariant with respect to frequency, set at a level about equal to the threshold of audibility at the human ear's most sensitive frequency. Since it is not, in general, possible to predict the spectrum of the artifacts, this approach ensures that the processing artifacts will also be below the threshold of hearing wherever they appear in the spectrum. In this case, the length of the crossfade (the crossfade window) should not affect audibility, but it may be desirable to use a relatively short crossfade in order to allow the most room for processing.

The human ear has a lack of sensitivity to discontinuities in predominantly high frequency waveforms (e.g., a high-frequency click, resulting from a high-frequency waveform discontinuity, is more likely to be masked or inaudible than is a low-frequency click). In this case, the components of the artifacts will also be predominantly high frequency and will be masked regardless of the signal magnitudes at the splice point (because of the steady-state or quasi-steady-state nature of the identified region, the magnitudes at the splice point will be similar to those of the signals in the identified region that act as maskers). This may be considered as a case of simultaneous masking. In this case, the length of the crossfade should not affect audibility, but it may be desirable to use a relatively short crossfade in order to allow the most room for processing.

If the splice point is within a region of the audio signal identified as being masked by a transient (i.e., either by premasking or postmasking), the magnitude of each of the signals being spliced, taking into account the applied crossfading characteristics, including the crossfading length, determines if a particular splice point will be masked by the transient. The amount of masking provided by a transient decays with time. Thus, in the case of premasking or post masking by a transient, it is desirable to use a relatively short crossfade, leading to a greater disturbance but one that lasts for a shorter time and that is more likely to lie within the time duration of the premasking or postmasking.

When the splice point is within a region of the audio signal that does not provide masking, an aspect of the present invention is to choose the quietest sub-segment of the audio signal within a segment of the audio signal (in practice, the segment may be a block of samples in a buffer memory). In this case, the magnitude of each of the signals being spliced, taking into account the applied crossfading characteristics, including the crossfading length, determines the extent to which the artifacts caused by the splicing disturbance will be audible. If the level of the sub-segment is low, the level of the artifact components will also be low. Depending on the level and spectrum of the low sub-segment, there may be some simultaneous masking. In addition, the higher level portions of the audio surrounding the low-level sub-segment may also provide some temporal premasking or postmasking, raising the threshold in the crossfade window. The artifacts may not always be inaudible, but will be less audible than if the splice had been performed in the louder regions. Such audibility may be minimized by employing a longer crossfade length and matching well the waveforms at the splice point. However, a long crossfade limits the length and position of the target segment, since it effectively lengthens the passage of audio that is going to be altered and forces the splice and/or end points to be further from the ends of the block (in a practical case in which the audio samples are divided into blocks). Hence, the maximum crossfade length is a compromise.

As previously noted, in practice, the audio signals may be represented by blocks of samples that, in turn, may be stored in a buffer memory. Consequently, a decision should be made with respect to each block (or, alternatively, only with respect to certain blocks) as to whether data compression or expansion is to be applied to that block of audio data. As discussed below, if the characteristics of the audio represented by a particular block are such that a splice would result in audible artifacts, processing of that block may be skipped.

FIGS. 2A and 2B illustrate schematically the concept of data compression by removing a target segment, while FIGS. 2C and 2D illustrate schematically the concept of data expansion by repeating a target segment. In practice, the data compression and data expansion processes are applied to data in one or more buffer memories, the data being samples representing an audio signal.

Although the identified regions in FIGS. 2A through 2D satisfy the criterion that they are postmasked as the result of a signal transient, the principles underlying the examples of FIGS. 2A through 2D also apply to identified regions that satisfy other criteria, including the other three mentioned above.

Referring to FIG. 2A, illustrating data compression, an audio stream 102 has a transient 104 that results in a portion of the audio stream 102 being a psychoacoustically postmasked region 106 constituting the “identified region”. The audio stream is analyzed and a splice point 108 is chosen to be within the masked region 106. As explained further below in connection with FIGS. 3A and 3B, if the audio stream is represented by a block of data in a buffer, there is a minimum splice point (i.e., if the data stream is represented by samples, it has a low sample number) and a maximum splice point (i.e., if the data stream is represented by samples, it has a high sample number) within the buffer. Analysis continues on the audio stream and an end point 110 is chosen. The analysis includes an autocorrelation of the audio stream 102 in a region 112 from the splice point 108 forward (toward higher sample numbers) up to a maximum processing point 114. As explained further below, the autocorrelation seeks a correlation maximum between a minimum processing point 116 and the maximum processing point 114 and may employ time-domain correlation or both time-domain correlation and phase correlation. A way to determine the maximum and minimum processing points is described below. End point 110 is at a time subsequent to the splice point 108 (i.e., if the data stream is represented by samples, it has a higher sample number). The splice point 108 defines a leading segment 118 of the audio stream that leads the splice point (i.e., if the data stream is represented by samples, it has lower sample numbers than the splice point). The end point 110 defines a trailing segment 120 that trails the end point (i.e., if the data stream is represented by samples, it has higher sample numbers than the end point). The splice point 108 and the end point 110 define the ends of a segment of the audio stream, namely the target segment 122. End point 110 need not be within the identified region, but for some signal conditions, the suppression of audibility of the splicing artifacts is enhanced if it is within the identified region.

For data compression, the target segment is removed and in FIG. 2B the leading segment is joined, butted or spliced together with the trailing segment at the splice point using crossfading (not shown in this figure), the splice point remaining within the masked region 106. As explained further below, the splice point is windowed by a crossfading region. Thus, the splice “point” may be characterized as the center of a splice “region”. Components of the splicing artifacts remain principally within the time window of the crossfade, which is within the masked region 106, minimizing the audibility of the data compression. In FIG. 2B, the data compressed data stream is identified by reference numeral 102′.

Throughout the various figures the same reference numeral will be applied to like elements, while reference numerals with prime marks will be used to designate related, but modified elements.

Referring to FIG. 2C, illustrating data expansion, an audio stream 124 has a transient 126 that results in a portion of the audio stream 124 being a psychoacoustically postmasked region 128 constituting the “identified region”. In the case of data expansion, the signal stream is analyzed and a splice point 130 is also chosen to be within the masked region 128. As explained further below, if the audio stream is represented by a block of data in a buffer, there is a minimum splice point and a maximum splice point within the buffer. The signal stream is analyzed both forwards (higher sample numbers, if the data is represented by samples) and backwards (lower sample numbers, if the data is represented by samples) from the splice point in order to locate an end point. This forward and backward searching is performed to find data before the splice point that is most like the data at and after the splice point that will be appropriate for copying and repetition. More specifically, the forward searching is from the splice point 130 up to a first maximum processing point 132 and the backward searching is performed from the splice point 130 back to a second maximum processing point 134. The two maximum processing points may be, but need not be, spaced the same number of samples away from the splice point 130. As explained further below, the two signal segments from the splice point to the respective maximum processing points are cross-correlated in order to seek a correlation maximum. The cross correlation may employ time-domain correlation or both time-domain correlation and phase correlation.

Contrary to the data compression case of FIGS. 2A and 2B, the end point 136 is at a time preceding the splice point 130 (i.e., if the data stream is represented by samples, it has a lower sample number). The splice point 130 defines a leading segment 138 of the audio stream that leads the splice point (i.e., if the data stream is represented by samples, it has lower sample numbers than the splice point). The end point 136 defines a trailing segment 140 that trails the end point (i.e., if the data stream is represented by samples, it has higher sample numbers than the end point). The splice point 130 and the end point 136 define the ends of a segment of the audio stream, namely the target segment 142. Thus, the definitions of splice point, end point, leading segment, trailing segment, and target segment are the same for the case of data compression and the case of data expansion. However, in the data expansion case of FIG. 2C, the target segment is part of both the leading segment and the trailing segment, whereas in the data compression case the target segment is part of neither.

In FIG. 2D the leading segment is joined together with the target segment at the splice point using crossfading (not shown in this figure), causing the target segment to be repeated in the resulting audio stream 124′. In this case, of data expansion, end point 136 should be within the identified region 128 of the original audio stream (thus placing all of the target segment in the original audio stream within the identified region). The first rendition 142′ of the target segment (the part which is a portion of the leading segment) and the splice point 130 remain within the masked region 128. The second rendition 142″ of the target segment (the part which is a portion of the trailing segment) is after the splice point 130 and may, but need not, extend outside the masked region 128. However, this extension outside the masked region has no audible effect because the target segment is continuous with the trailing segment in both the original audio and in the time-compressed version.

A target segment should not include a transient in order to avoid omitting the transient, in the case of compression, or repeating the transient, in the case of expansion. Hence, the splice and end points should be on the same side of the transient (i.e., both are earlier than (i.e., if the data stream is represented by samples, they have lower sample numbers) or later than (i.e., if the data stream is represented by samples, they have higher sample numbers) the transient.

Another aspect of the present invention is that the audibility of a splice may be further reduced by windowing the crossfade and by varying the shape and duration of the windowing in response to the audio signal. Further details of crossfading are set forth below in connection with FIG. 9 and its description.

FIGS. 3A and 3B set forth an example of determining the minimum and maximum splice points within a buffer containing a block of samples representing the input audio. The minimum splice point has a lower sample number than the maximum splice point. The minimum and maximum location of the splice point is related to the length of the crossfade used in splicing and the maximum length of the processing region. Determination of the maximum length of the processing region is explained in connection with FIG. 4 For time scale compression, the processing region is the region of audio data after the splice point used in autocorrelation processing to identify an appropriate end point. For time scale expansion, there are two processing regions, which may be, but need not be, of equal length, one before and one after the splice point. They define the two regions used in cross-correlation processing to determine an appropriate end point.

Every buffer (block of audio data) has a minimum splice point and a maximum splice point. As show in FIG. 3A, the minimum splice point in the case of compression is limited only by the length of the crossfade because the audio data around the splice point is crossfaded with the audio data around the end point. Similarly, for time scale compression, the maximum splice point is limited by the possibility that the end point chosen by correlation processing could be spaced from the splice point by the maximum length of the processing region and that a crossfade would require access to data both before and after the end point.

FIG. 3B outlines the determination of the minimum and maximum splice points for time scale expansion. The minimum splice point for time scale expansion is related to the maximum length of the processing region and the crossfade length in a manner similar to the determination of the maximum splice point for time scale compression. The maximum splice point for time scale expansion is related only to the maximum processing length. This is because the data following the splice point for time scale expansion is used only for correlation processing and an end point will not be located after the maximum splice point.

As shown in FIG. 4, for the case of time scale compression, the processing region used for correlation processing is located after the splice point. Minimum and maximum processing points define the length of the processing region. The minimum processing point indicates the minimum value after the splice point that the computed end point may be located. Similarly, the maximum processing point indicates the maximum value after the splice point that the end point may be located. The minimum and maximum splice points control the amount of data that may be used for the target segment and may be assigned default values (usable values are 7.5 and 25 msec respectively). Alternatively, these values may be variable so as to change dynamically depending on the audio content and the desired amount of time scaling. For example, for a signal whose predominant frequency component is 50 Hz and is sampled at 44.1 kHz, a single period of the audio waveform will be approximately 882 samples in length (or 20 msec). This indicates that the maximum processing length must be of sufficient length to contain at least one cycle of the audio data. Similarly, if the minimum processing length is chosen to be 7.5 msec and the processed audio contains a signal that generally selects an end point that is near the minimum processing point, then the maximum percentage of time scaling is dependent upon the length of each input data buffer. For example, if the input data buffer size is 4096 samples (or 93 msec roughly), than a minimum processing length of 7.5 msec would result in a maximum time scale rate of 7.5/93=8% if the minimum processing point were selected. These examples show the benefit of allowing the minimum and maximum processing points to vary depending upon the audio content and the desired time scale percentage. For example, the minimum processing point for time scale compression may be set to 7.5 msec (331 samples for 44.1 kHz) for rates less than 7% change and set equal to:

Minimum processing length=((time_scale_rate−1.0)* window_size);

where time_scale_rate is >1.0 for time scale compression (1.10=10% increase in rate of playback), and the window_size is currently 4096 samples at 44.1 kHz.

A further aspect of the invention is that in order to further reduce the possibility of an audible splice, a comparison technique may be employed to match the signal waveforms at the splice point and the end point so as to lessen the need to rely on masking or inaudibility. A matching technique that constitutes a further aspect of the invention is seeking to match both the amplitude and phase of the waveforms that are joined at the splice. This in turn may involve correlation, which also is an aspect of the invention. Correlation may include compensation for the variation of the ear's sensitivity with frequency.

In accordance with another aspect of the invention, a method is provided for time scaling and/or pitch shifting multiple channels of audio signals, each signal represented by samples. Each of the audio signals is analyzed using at least one psychoacoustic criterion to identify at least one region in each of the audio signals in which the omission of a portion of the audio signal or the repetition of a portion of the audio signal is inaudible or minimally audible. A common splice point in one of the regions in each of the audio signals is selected, thereby defining a leading segment of the audio signal that leads the splice point, wherein the splice points in the multiple channels of audio signals are selected to be substantially aligned with one another. An end point spaced from the splice point in each of the audio signals is selected, thereby defining a trailing segment of the audio signal trailing the endpoint and a target segment of the audio signal between the splice and end points, wherein the end points in the multiple channels of audio signals are selected to be substantially aligned with one another. The leading and trailing segments are joined at the splice point in each of the audio signals, thereby decreasing the number of audio signal samples by omitting the target segment when the end point has a higher sample number than the splice point, or increasing the number of samples by repeating the target segment when the end point has a lower sample number than the splice point. The joined leading and trailing segments in each of the audio signals are read out at a rate that yields a desired time duration for the multiple channels of audio and a desired time scaling and/or pitch shifting for the multiple channels of audio. For example, (1) a time duration the same as the original time duration results in pitch shifting the audio signals, (2) a time duration decreased by the same proportion as the relative change in the reduction in the number of samples, in the case of omitting the target segment, results in time compressing the audio signals, (3) a time duration increased by the same proportion as the relative change in the increase in the number of samples, in the case of repeating the target segment, results in time expanding the audio signals, (4) a time duration decreased by a proportion different from the relative change in the reduction in the number of samples results in time compressing and pitch shifting the audio signals, and (5) a time duration increased by a proportion different from the relative change in the increase in the number of samples results in time expansion and pitch shifting the audio signals.

In both single channel and multichannel environments, the resultant length of the target segment may not be correct for the desired degree of compression or expansion. Thus, a further aspect of the invention keeps a running total of the cumulative compression/expansion to determine whether a possible splicing operation should occur or not.

In a practical embodiment set forth herein, audio is divided into sample blocks. However, the principles of the various aspects of the invention do not require arranging the audio into sample blocks, nor, if they are, of providing blocks of constant length. When the audio is divided into blocks, a further aspect of the invention, in both single channel and multichannel environments, is not to process certain blocks.

Other aspects of the invention will be appreciated and understood as the detailed description of the invention is read and understood.

### BRIEF DESCRIPTION OF THE DRAWINGS

FIG. 1 is an idealized plot of a human hearing threshold in the presence of no sounds and in the presence of a 500 Hz sine wave. The horizontal scale is frequency in Hertz (Hz) and the vertical scale is in decibels (dB).

FIGS. 2A and 2B are schematic conceptual representations illustrating the concept of data compression by removing a target segment. The horizontal axis represents time.

FIGS. 2C and 2D are schematic conceptual representations illustrating the concept of data expansion by repeating a target segment. The horizontal axis represents time.

FIG. 3A is a schematic conceptual representation of a block of audio data in a buffer represented by samples, showing the minimum splice point and maximum splice point in the case of data compression. The horizontal axis is samples and represents time. The vertical axis is normalized amplitude.

FIG. 3B is a schematic conceptual representation of a block of audio data in a buffer represented by samples, showing the minimum splice point and maximum splice point in the case of data expansion. The horizontal axis is samples and represents time. The vertical axis is normalized amplitude.

FIG. 4 is a schematic conceptual representation of a block of audio data in a buffer represented by samples, showing the splice point, the minimum processing point, the maximum processing point and the processing region. The horizontal axis is samples and represents time. The vertical axis is normalized amplitude.

FIG. 5 is a flow chart setting forth a multichannel time and pitch-scaling process according to an aspect of the present invention.

FIG. 6 is a flow chart showing details of the psychoacoustic analysis step 206 of FIG. 5.

FIG. 7 is a schematic conceptual representation of a block of data samples in a transient analysis buffer. The horizontal axis is samples in the buffer.

FIG. 8 is a schematic conceptual representation showing an audio buffer analysis example in which a 450 Hz sine wave has a middle portion 6 dB lower in level than its beginning and ending sections in the buffer. The horizontal axis is samples representing time and the vertical axis is normalized amplitude.

FIG. 9 is a schematic conceptual representation showing how crossfading may be implemented, showing an example of buffer splicing and a nonlinear crossfading in accordance with a Hanning window of the time-domain information of a highly periodic portion of the exemplary speech signal of FIG. 12. The horizontal scale represents time and the vertical scale is amplitude.

FIG. 10 is a flowchart showing details of the multichannel splice processing selection step 210 of FIG. 5.

FIG. 11 is a series of idealized waveforms in four audio channels representing blocks of audio data samples, showing an identified region in each channel, each satisfying a different criterion, and showing the overlap of identified regions in which a common multichannel splice point may be located. The horizontal axis is samples and represents time. The vertical axis is normalized amplitude.

FIG. 12 shows the time-domain information of a highly periodic portion of an exemplary speech signal. An example of well-chosen splice and end processing points that maximize the similarity of the data on either side of the discarded data segment are shown. The horizontal scale is samples representing time and the vertical scale is amplitude.

FIG. 13 is an idealized depiction of waveforms, showing the instantaneous phase of a speech signal, in radians, superimposed over a time-domain signal, x(n). The horizontal scale is samples and the vertical scale is both normalized amplitude and phase (in radians).

FIG. 14 is a flow chart showing details of the correlation steps 214 of FIG. 5. FIG. 14 includes idealized waveforms showing the results of phase correlations in each of five audio channels and the results of time-domain correlations in each of five channels. The waveforms represent blocks of audio data samples. The horizontal axes are samples representing time and the vertical axes are normalized amplitude.

FIG. 15 is a schematic conceptual representation that has aspects of a block diagram and a flow chart and which also includes an idealized waveform showing an additive-weighted-correlations analysis-processing example. The horizontal axis of the waveform is samples representing time and the vertical axis is normalized amplitude.

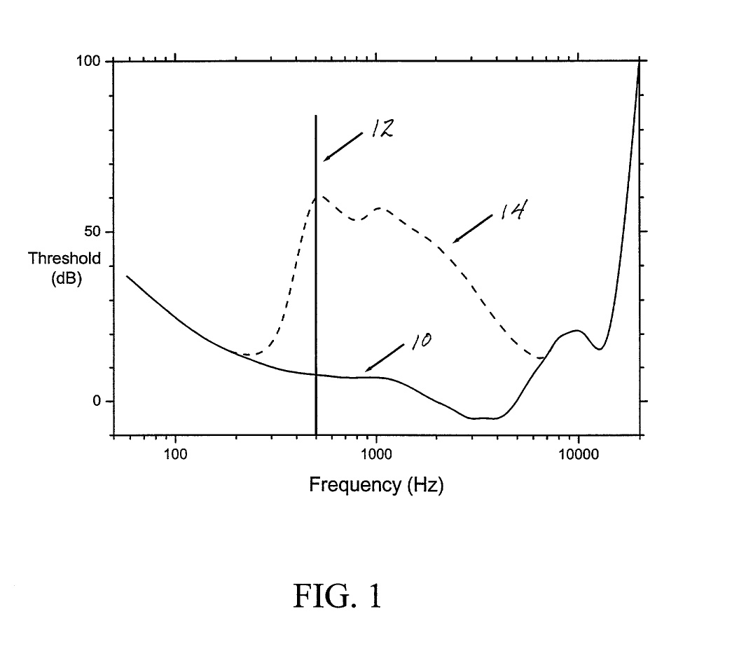

### DETAILED DESCRIPTION OF THE PREFERRED EMBODIMENTS

A flow chart setting forth a single channel or multichannel time-scaling and pitch-scaling process according to an aspect of the present invention is shown in FIG. 5. Other aspects of the invention form portions or variations of the overall FIG. 5 process. The overall process may be used to perform real-time pitch scaling and non-real-time pitch and time scaling. A low-latency time-scaling process cannot operate effectively in real time since it would have to buffer the input audio signal to play it at a different rate thereby resulting in either buffer underflow or overflow—the buffer would be emptying at a different rate than input data is being received.

### Input Data

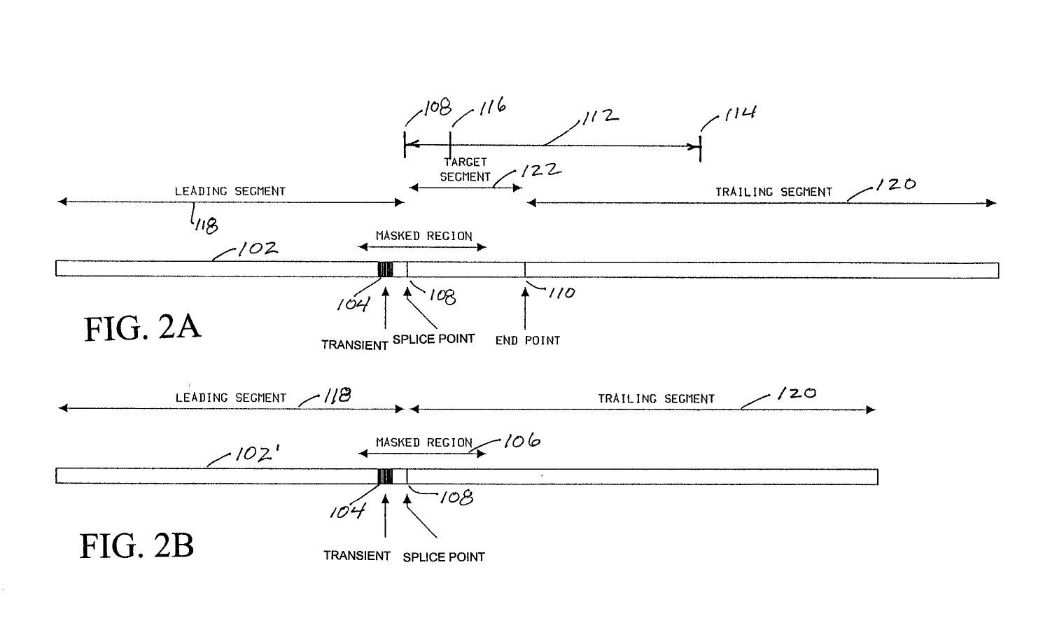

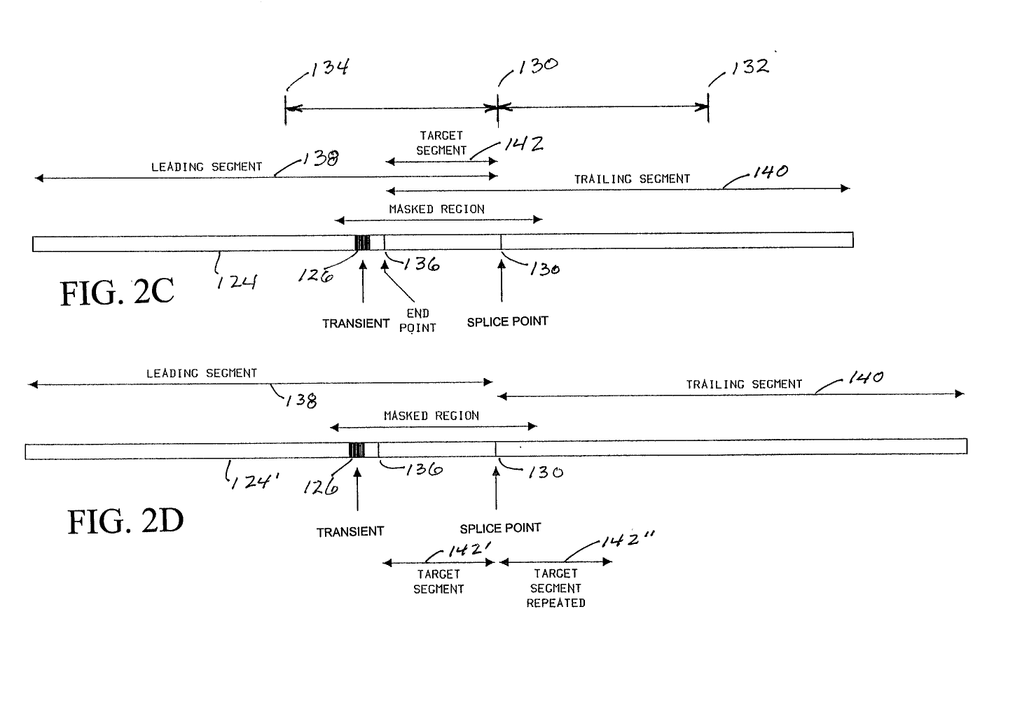

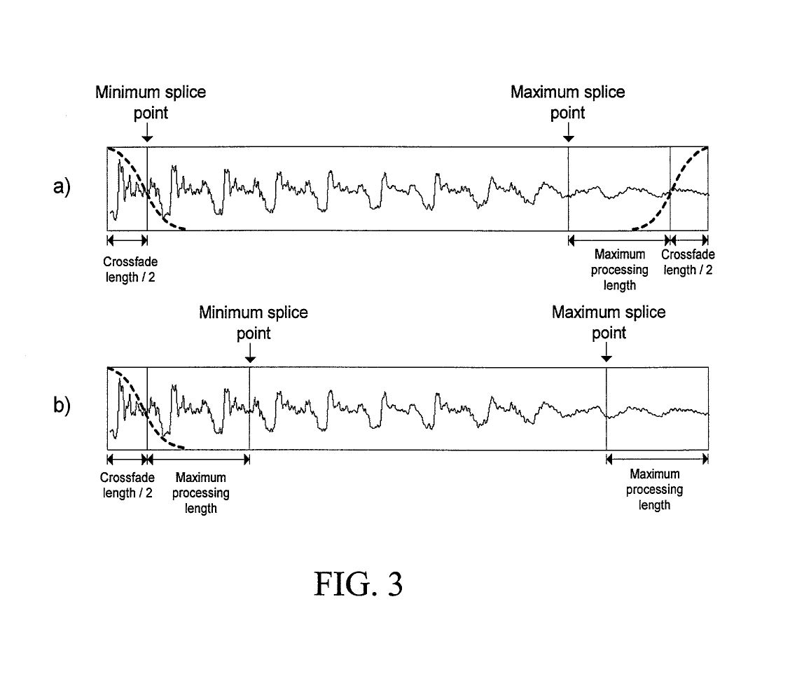

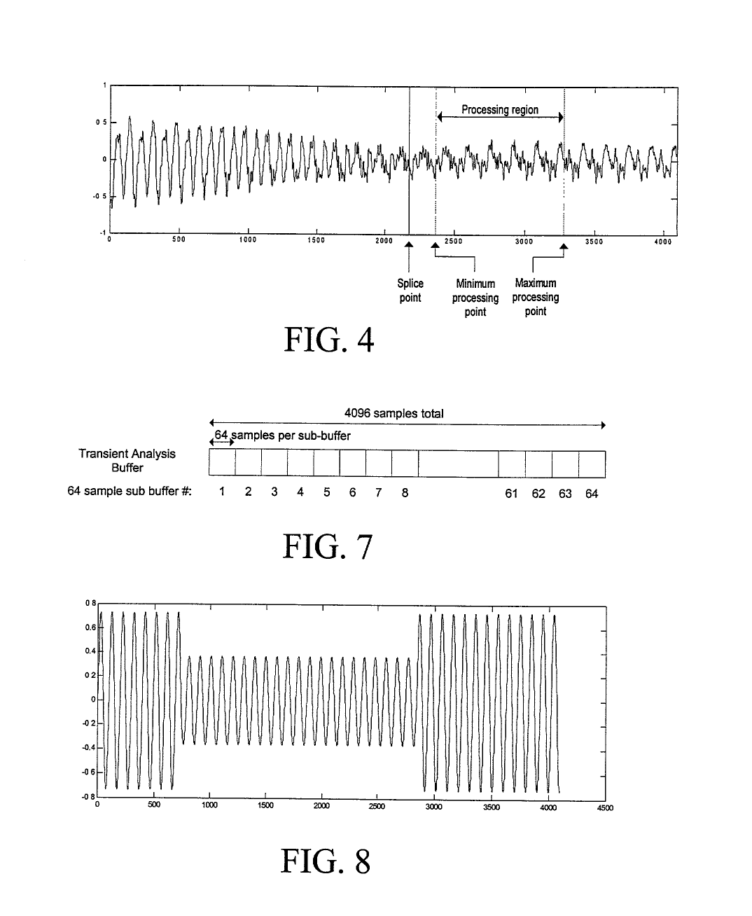

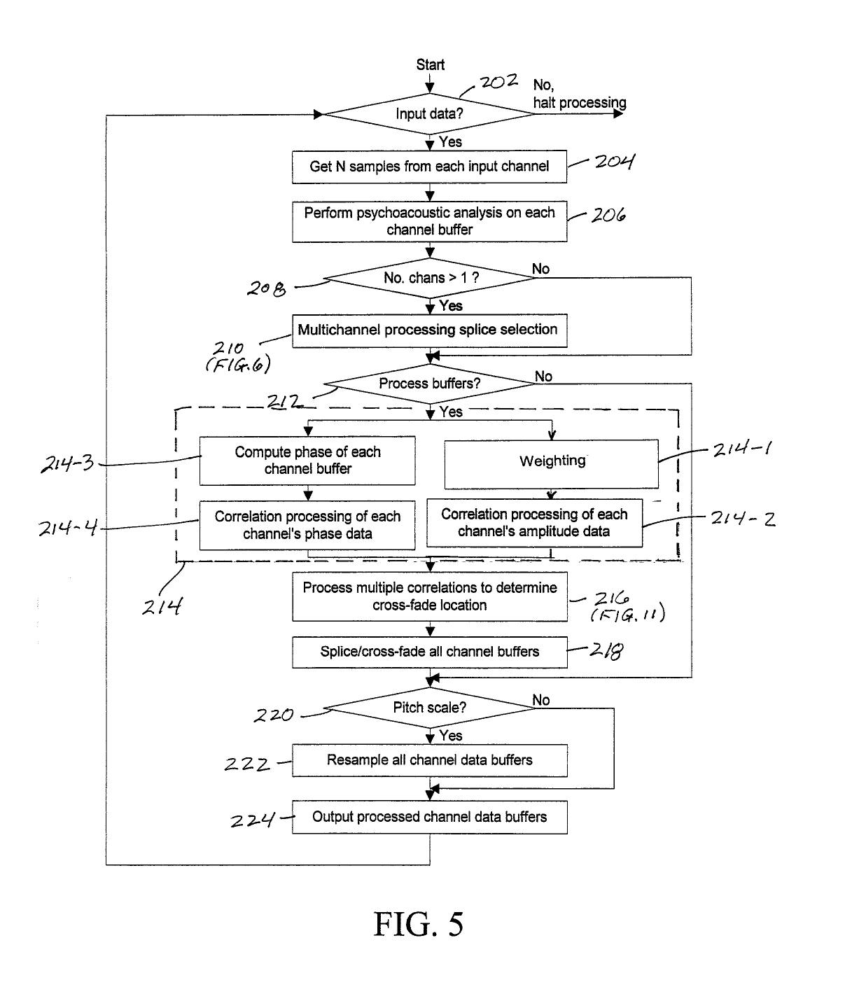

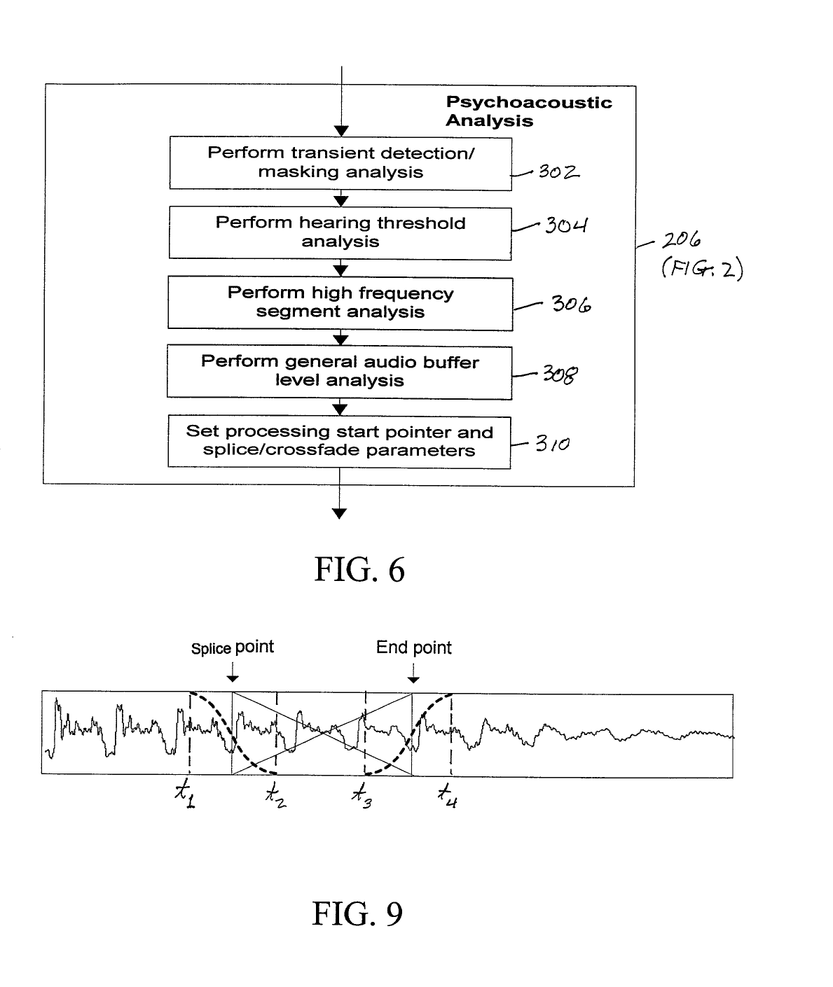

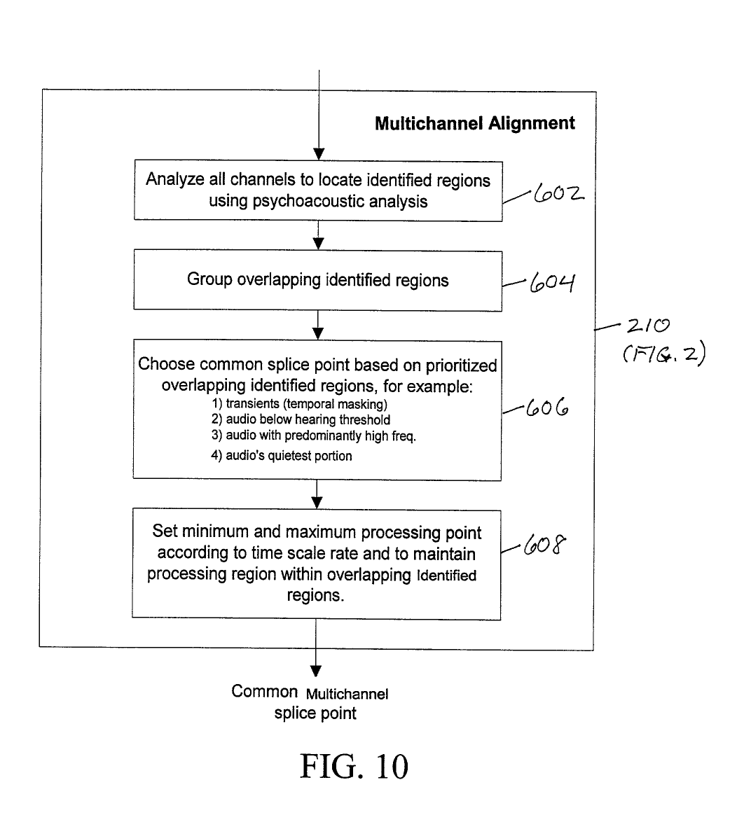

Referring to FIG. 2, the first step 202 is to determine whether digitized input audio data is available for processing. The source of the data may be a computer file or an input buffer, which may be a real-time input buffer, for example. If data is available, buffers containing N time synchronous samples are accumulated 204 for each of the input channels to be processed (with the number of allowed channels being >=1). The number of input data samples, N, used by the process may be fixed at any reasonable number of samples.

In a practical embodiment, the process's parameters may be selected to perform processing, for example, on approximately 90 msec of input audio data (which corresponds to N set equal to 4096 samples at a sampling rate of 44.1 kHz). FIG. 5 will be discussed in connection with a practical embodiment of aspects of the invention in which the input data is processed in blocks of 4096 samples which corresponds to about 90 msec of input audio at a sampling rate of 44.1 kHz. It will be understood that the aspects of the invention are not limited to such a practical embodiment. However, the selection of this amount of input data is useful for three primary reasons. First, it provides low enough latency to be acceptable for real-time processing applications. Second, it is a power-of-two number of samples, which is useful for fast Fourier transform (FFT) analysis. Third, it provides a suitably large window size to perform a useful psychoacoustic analysis of the input signal.

### Psychoacoustic Analysis 206 (FIG.5)

Following input channel data buffering, psychoacoustic analysis 206 is performed on each input channel data buffer. Further details of step 206 are shown in FIG. 6. Analysis 206 identifies regions in all channels satisfying the psychoacoustic criteria, and also determines potential splice points within those regions. If there is only one channel, subsequent step 210 is skipped and the best of the potential splice points from 206 is used (chosen in accordance with the hierarchy of criteria). For the multichannel case, element 210 (in particular 602 in FIG. 10) re-examines the identified regions and chooses the best common splice point, which may be, but is not necessarily, one of those identified in analysis 206. The employment of psychoacoustic analysis to minimize audible artifacts in time compression and expansion of audio data (and in time and pitch scaling) is an aspect of the present invention. Psychoacoustic analysis may include applying one or more of the four criteria described above or other criteria that identifies segments of audio that would suppress or minimize artifacts arising from splicing waveforms.

FIG. 6 is a flow chart of the operation of the psychoacoustic analysis process 206 of FIG. 5. The psychoacoustic analysis process 206 is composed of five general processing steps or sub-steps. The first four are psychoacoustic criteria arranged in a hierarchy such that an audio region satisfying the first step or first criterion has the greatest likelihood of a splice within the region being inaudible or minimally audible, with subsequent criteria having less and less likelihood of a splice within the region being inaudible or minimally audible.

### Transient Detection (FIG. 6)

Process 302 analyzes the input buffer and determines the location of audio signal transients, if any. The temporal transient information is used in masking analysis and the placement of a buffer splice point pointer (the last sub-step in the psychoacoustic analysis process). As discussed above, it is well known that transients introduce temporal masking (hiding audio information both before and after the occurrence of transients).

The first sub-step in the transient detection 302 is to filter the input data buffer (treating the buffer contents as a time function). The input buffer data is high-pass filtered, for example with a 2^{nd} order IIR high-pass filter with a 3 dB cutoff frequency of approximately 8 kHz. The cutoff frequency and filter characteristics are not critical. Filtered buffer data along with the original unfiltered buffer data is then used in the transient analysis. The use of the full bandwidth and high-pass filtered buffers enhances the ability to identify transients even in complex material, such as music. The data may also be high-pass filtered by one or more additional filters having other cutoff frequencies. High frequency transient components of a signal may have amplitudes well below stronger lower frequency components but may still be highly audible to a listener. Filtering the input data isolates the high frequency transients and makes them easier to identify. Next, both the full range and filtered input buffers may be processed in sub-blocks of approximately 1.5 msec (or 64 samples at 44.1 kHz) as shown in FIG. 7. While the actual size of the processing buffer is not constrained to 1.5 msec and may vary, this size provides a good trade-off between real-time processing requirements (larger sub-block sizes require less processing overhead) and resolution of transient location (smaller sub-blocks provide more detailed information on the location of a transient).

The second sub-step of transient detection 302 is to perform a low-pass filtering or leaky averaging of the maximum absolute data values contained in each 64-sample sub-block (treating the data values as a time function). This processing is performed to smooth the maximum absolute data and provide a general indication of the average peak values in the input buffer to which the actual sub-buffer maximum absolute data value can be compared.

The third sub-step of transient detection 302 compares the peak in each sub-block to the array of smoothed, moving average peak values to determine whether a transient exists. While a number of methods exist to compare these two measures, the approach outlined below allows tuning of the comparison by use of a scaling factor that has been set to perform optimally as determined by analyzing a wide range of audio signals.

The peak value in the k^{th} sub-block, for both the unfiltered and filtered data, is multiplied by the full or high frequency scaling value and compared to the computed smoothed, moving average peak value of each k. If either sub-block's scaled peak value is greater than the moving average value a transient is flagged as being present.

Following transient detection, several corrective checks are made to determine whether the transient flag for a 64-sample sub-block should be cancelled (reset from TRUE to FALSE). These checks are performed to reduce false transient detections. First, if either the full range or high frequency peak values fall below a minimum peak value then the transient is cancelled (to address low level transients). Secondly, if the peak in a sub-block triggers a transient but is not significantly larger than the previous sub-block, which also would have triggered a transient flag, then the transient in the current sub-block is cancelled. This reduces a smearing of the information on the location of a transient. The number of transients and the location of each for an input channel data buffer are stored for later use in the psychoacoustic analysis step.

The invention is not limited to the particular transient detection just described. Other suitable transient detection schemes may be employed.

### Hearing Threshold Analysis 304 (FIG. 6)

Referring still to FIG. 6, the second step 304 in the psychoacoustic analysis process, the hearing threshold analysis, determines the location and duration of audio segments that have low enough signal strength that they can be expected to be at or below the hearing threshold. As discussed above, these audio segments are of interest because the artifacts introduced by time scaling and pitch shifting are less likely to be audible in such regions.

It is well understood that the threshold of hearing is a function of frequency (with lower and higher frequencies being less audible than middle frequencies). In order to minimize processing for real-time processing applications, the hearing threshold model for analysis may assume a uniform threshold of hearing (where the threshold of hearing in the most sensitive ranges of frequency are applied to all frequencies). This assumption reduces the requirement of performing frequency dependent processing on the input data prior to low energy processing. In addition, as explained below, additional processing may take advantage of the frequency dependent sensitivity of hearing using methods that are more efficient.

The hearing threshold analysis step may also processes the input in approximately 1.5 msec sub-blocks (64 samples for 44.1 kHz input data) and may use the same smoothed, moving average calculation mentioned above. Following this calculation, the smoothed, moving average value for each sub-block is compared to a threshold value to determine whether the sub-block can be flagged as being an inaudible sub-block. The location and duration of each segment in the input buffer is stored for later use in the analysis step. A string of contiguous flagged sub-blocks may be sufficiently long to be a useful location for a splice point or both a splice point and end point. In the analysis, it is useful to find the longest contiguous string of flagged sub-blocks for use as an identified region. As in the transient detection case, the size of the sub-blocks used in hearing threshold analysis is a trade-off between real-time processing requirements (as larger sub-block sizes require less processing overhead) and resolution of audio segment locations (smaller sub-blocks provide more detailed information on the location of hearing threshold segments).

### High Frequency Segment Analysis 306 (FIG. 6)

The third step 306, the high frequency segment analysis step, determines the location and length of audio segments that contain predominantly high frequency audio content. High frequency segments, above approximately 10-12 kHz, are of interest in the psychoacoustic analysis because the ear is less sensitive to discontinuities in a predominantly high frequency waveform than to discontinuities in waveforms predominantly of lower frequencies. While there are many methods available to determine whether an audio signal consists mostly of high frequency energy, the method described here provides good detection results and greatly minimizes computational requirements. Nevertheless, other methods may be employed. The method described does not categorize a region as being high frequency if it contains both strong low frequency content and high frequency content. This is because low frequency content is more likely to generate audible artifacts when processed using the time-scaling method.

The high frequency segment analysis step may also process the input buffer in 64-sample sub-blocks and it may use the zero crossing information of each sub-block to determine whether it contains predominantly high-frequency data. The zero-crossing threshold (i.e., how many zero crossings must exist in a buffer before it is labeled a high-frequency audio buffer) may be set such that it corresponds to a frequency in the range of approximately 10 to 12 kHz. In other words, a sub-block is flagged as containing high frequency audio content if it contains at least the number of zero crossings corresponding to a signal in the range of about 10 to 12 kHz signal (a 10 kHz signal has 29 zeros crossings in a 64-sample sub-block with a 44.1 kHz sampling frequency). As with previous analysis steps, the use of sub-blocks of a specific size provides a trade-off between computational complexity and resolution of high frequency audio segment location. As in the case of the hearing threshold analysis, a string of contiguous flagged sub-blocks may be sufficiently long to be a useful location for a splice point or both a splice point and end point. In the analysis, it is useful to find the longest contiguous string of flagged sub-blocks for use as an identified region.

The invention is not limited to the particular high-frequency detection just described. Other suitable detection schemes may be employed.

### Audio Buffer Level Analysis 308 (FIG. 6)

The fourth step 308 in the psychoacoustic analysis process, the audio buffer level analysis, analyzes the input channel data buffer and determines the location of the audio segments of lowest signal strength (amplitude) in the input channel data buffer. The audio buffer level analysis information is used if the current input buffer contains no psychoacoustic masking events that can be exploited during processing (for example if the input is a steady state signal that contains no transients or audio segments below the hearing threshold). In this case, the time-scaling processing will favor the lowest level or quietest segments of the input buffer's audio with the rationale that lower level segments of audio will result in low level or inaudible splicing artifacts. A simple example using a 450 Hz tone (sine wave) is shown below in FIG. 8. The tonal signal shown in FIG. 5 contains no transients, below hearing threshold or high frequency content. However, the middle portion of the signal is 6 dB lower in level than the beginning and ending sections of the signal in the buffer. It is believed that focusing attention of the quieter, middle section rather than the louder end sections minimizes the audible processing artifacts.

While the input audio buffer may be separated into any number of audio level segments of varying lengths, it has been found suitable to divide the buffer into three equal parts so that the audio buffer level analysis is performed over the first, second and final third portions of the signal in each channel buffer to seek one portion or two contiguous portions that are quieter than the remaining portion(s). Alternatively, in a manner analogous to the sub-block analysis of the buffers for the below hearing threshold and high-frequency criteria, the buffer sub-blocks may be ranked according to their peak level with the longest contiguous string of the quietest of them constituting the quietest portion of the buffer.

### Setting Splice Point and Crossfade Parameters 310 (FIG. 6)

The final step 310 in the psychoacoustic analysis process of FIG. 6, the set splice point and crossfade parameter step, uses the information gathered from the previous steps and sets the splice point and the crossfade length. If transient signals are present, the splice point preferably is located within the temporal masking region before or after the transient, depending upon the transient location in the buffer and whether time expansion or contraction processing is being performed, to avoid repeating or smearing the transient (i.e., preferably, no portion of the transient should be within the crossfade window). The transient information is also used to determine the crossfade length.

As mentioned above, crossfading is used to minimize audible artifacts. FIG. 9 illustrates how to apply crossfading. The resulting crossfade will straddle the splice point where the waveforms are joined together. In FIG. 9 the dashed line starting before the splice point shows a non-linear downward fade from a maximum to a minimum amplitude applied to the signal waveform, being half way down at the splice point. The fade across the splice point is from time t₁ to t₂. The dashed line starting before the end point shows a complementary non-linear upward fade from a minimum to a maximum amplitude applied to the signal waveform, being half way up at the end point. The fade across the end point is from time t₃ to t₄. The fade up and fade down are symmetrical and sum to unity. The time duration from t₁ to t₂ is the same as from t₃ to t₄. In this time compression example, it is desired to discard the data between the splice point and end point (shown x'ed out). This is accomplished by discarding the data between the sample representing t₂ and the sample representing t₃. Then, the splice point and end point are (conceptually) placed on top of each other so that the data from t₁ to t₂ and t₃ to t₄ sum together, resulting in a crossfade windowed by the complementary upfade and downfade characteristics.

In general, longer crossfades mask the audible artifacts of splicing better than shorter crossfades. However, the length of a crossfade is limited by the fixed size of the input channel data buffer. Longer crossfades also reduce the amount of data that can be used for time scaling processing. This is because the crossfades are limited by the buffer boundaries and data before and after the current data buffer may not be available for use in processing and crossfading. However, the masking properties of transients can be used to shorten the length of the crossfade with audible artifacts being masked by the transient.

While a varying crossfade length may be used depending upon audio content, a suitable default crossfade length is 10 msec because it introduces minimal audible splicing artifacts for a wide range of material. Transient postmasking and premasking allow the crossfade length to be set somewhat shorter, for example, 5 msec.

If no signal transients are present, the splice point step analyzes the hearing threshold segment, high frequency, and general audio buffer level segment analysis results. If a low level, at or below the hearing threshold segment exists, the splice point will be set within the segment minimizing audible processing artifacts. If no below hearing threshold segments are present, the step searches for any high-frequency segments of the data buffer. High-frequency audio segments benefit from an increased hearing threshold for high frequency splicing artifacts. If no high-frequency segments are found, the step then searches for any low level audio segments. The lowest general audio level segment of the input buffer may benefit from some masking by the louder segments of the input data buffer. Alternatively, further criteria (or all criteria) may be searched even if a criterion is satisfied. This may be useful in finding a common splice point among multiple channels as described further below.

The psychoacoustic analysis process of FIG. 6 (step 206 of FIG. 5) identifies regions within which potential splice points for each input channel data buffer will lie. It also provides an identification of the criterion used to identify the potential splice point (whether, for example, transient, hearing threshold, high frequency, lowest audio level) and the number and locations of transients in each channel data buffer, all of which are useful in determining a common splice point among the channels and for other purposes, as described further below.

As stated above, the psychoacoustic analysis process of FIG. 6 is applied to each channel's input data buffer. If more than one audio channel is being processed, as determined by decision block 208, it is likely that the splice points will not be coincident across the multiple channels (some or all channels may contain audio content unrelated to other channels). The next step 210 uses the information returned by the psychoacoustic analysis step to identify regions in the multiple channels such that a common splice point may be selected across the multiple channels.

### Multichannel Splice Point Selection (FIG. 10)

FIG. 10 shows details of the multichannel splice point selection analysis step 210 of FIG. 5. Although, as an alternative, the best overall splice point may be selected from among the potential splice points in each channel determined by step 206 of FIG. 5, it is preferred to choose a potentially more optimized common splice point within the overlapped identified regions, which splice point may be different from all of the potential splice points determined by step 206 of FIG. 5. The identified regions of different channels may not precisely coincide, but it is sufficient that they overlap so that the common splice point among channels preferably is within an identified region in each channel (cross-channel masking may mean that some channels need not have an identified region; e.g., a masking signal from another channel may make it acceptable to perform a splice in a region in which a splice would not be acceptable if the channel were listened to in isolation). The identified regions of different channels need not have resulted from the same criterion. The multichannel splice processing selection step selects only a common splice point for each channel and does not modify or alter position or content of the channel data itself.

It is preferred that a common splice point is selected when processing multichannel audio in order to maintain phase alignment among multiple channels. This is particularly important for two channel processing where psychoacoustic studies suggest that shifts in the stereo image can be perceived with as little as 10 μs (microseconds) difference between the two channels, which corresponds to less than 1 sample at a sampling rate of 44.1 kHz. Phase alignment is also very important when surround-encoded material is processed. The phase relationship of surround-encoded stereo channels should be maintained or the decoded signal will be significantly degraded.

The multichannel splice point region selection process is composed of several decision blocks and processing steps. The first processing 602 analyzes all channels to locate the regions that were identified using psychoacoustic analysis, as describe above.

Processing 604 groups overlapping portions of identified regions. Next, processing 606 chooses a common splice point among the channels based on a prioritization or hierarchy of the criteria associated with each of the overlapping identified regions along with other factors including cross-channel masking effects. Process 606 also takes into account whether there are multiple transients in each channel, the proximity of the transients to one another and whether time compression or expansion is being performed. The type of time scaling is important in that it indicates whether the end point is located before or after the splice point (as shown in FIGS. 2A-D).

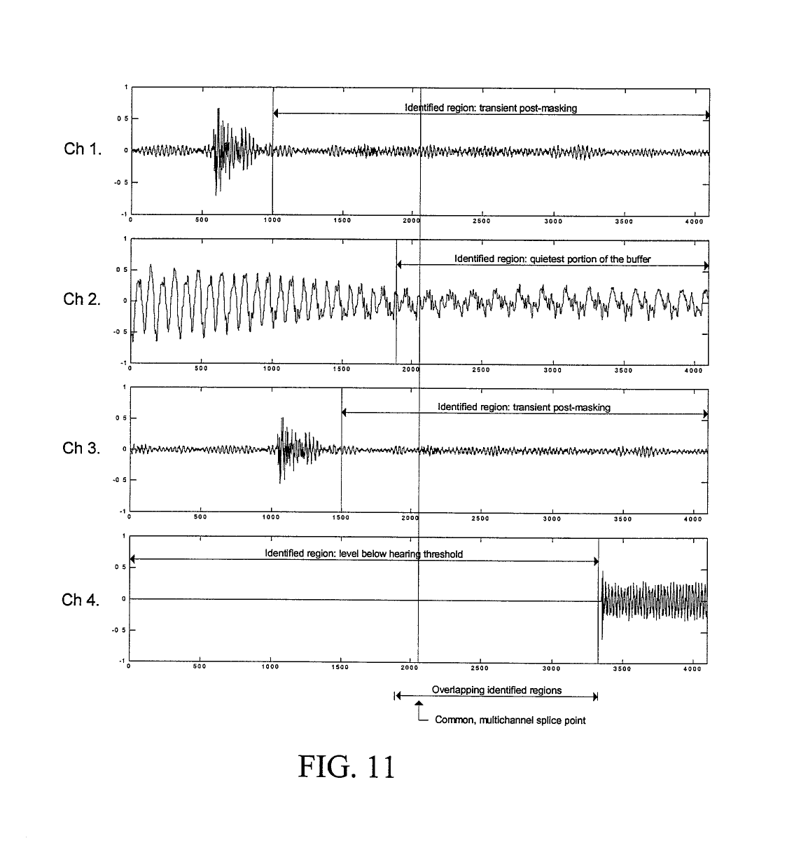

FIG. 11 shows an example of selecting a common multi-channel splice point for time scale compression using the regions identified in the individual channel psychoacoustic processing as being appropriate for performing processing. Channels 1 and 3 in FIG. 11 both contain transients that provide a significant amount of temporal post masking as shown in the diagram. The audio in Channel 2 in FIG. 11 contains audio that with a quieter portion that may be exploited for processing and is contained in roughly the second half of the audio buffer for Channel 2. The audio in Channel 4 contains a portion that is below the threshold of hearing and is located in roughly the first 3300 samples of the data buffer. The legend at the bottom of FIG. 11 shows the overlapping identified regions which provide a good overall region where processing can be performed with minimal audibility. The common splice point is chosen slightly after the start of the common overlapping identified regions to prevent the crossfade from transitioning between identified regions.

A common splice point should be chosen that is good for channels where the artifacts might otherwise be obvious. It may be poorer for other channels, but a sub-optimal choice may be acceptable because of cross-channel masking. Given the hierarchy of psychoacoustic phenomena for the choice of processing regions, in choosing a common splice point, one should assess the potential splice points in each channel against that hierarchy and accept an inferior point in some channels if that permits optimum performance in channels with transients or higher levels. The repetition or deletion of transients should be avoided.

In other words, it is preferable to find potential processing regions that overlap sufficiently that a common target segment can be defined meeting the desired criteria in all channels. If that is not possible, then the common splice point should be chosen to meet the criterion that failure to meet them is least likely to give rise to audible artifacts. For example, if a channel contains a transient, that should carry the most weight in deciding on a common splice point. If a channel contains a long passage of substantial silence, it should be given little weight, in that the position of the target segment is very uncritical. In effect, a silent portion reduces the number of channels.

In certain cases, it may not be practical to identify a common splice point, in which case a skip flag is set. For example, if there are multiple transients in one or more channels so that there is insufficient space for processing without deleting or repeating a transient or if there otherwise is insufficient space for processing, a skip flag may be set.

An alternative approach to determining a common splice point among channels is to treat each channel as though it were independent, determining a (usually different) splice point for each of them. Then, select one of the individual splice points as a common splice point based on determining which one of the individual splice points would cause the least objectionable artifacts if it were the common splice point.

Once a common splice point has been identified in block 606, processing block 608 sets minimum and maximum processing points according to the time scale rate (i.e., the desired ratio of data compression or expansion) in order to maintain the processing region within the overlapping portion of the identified regions and block 606 outputs the common multi-channel splice point for all channels (shown in FIG. 11) along with the minimum and maximum processing points. Block 606 may also output crossfade parameter information. The maximum processing length is important for the case where multiple inter-channel or cross-channel transients exist and the splice point is set such that channel buffer processing is to occur between transients. In setting the processing length correctly, it may be necessary to consider other transients in the processing in the same or other channels.

### Buffer Processing Decision 212 (FIG. 5)

The next step in processing, as shown in FIG. 5, is the buffer processing decision 212. This block first checks whether the processing skip flag has been set previously in the processing chain. If so, the current buffer (i.e., the current block of data) is not processed and the splice/splice processing is skipped. The buffer processing decision block also compares how much the data has been time scaled compared with the requested amount of time scaling. For example, in the case of compression, the decision block keeps a cumulative tracking of how much compression has been performed compared to the desired compression ratio. The output time scale factor varies from block to block, varying a slight amount around the requested time scale factor (it may be more or less than the desired amount at any given time). The buffer processing decision block compares the requested time scale factor, compares it to the output time scale factor, and makes a decision whether to process the current input data buffer. For example, if a time scale factor of 110% is requested and the output scale factor is below the requested scale factor, the current input buffer will be processed. Otherwise the current buffer will be skipped. Alternatively, other criteria may be employed. For example, instead of basing the decision of whether to skip the current buffer on whether the current accumulated expansion or compression is more than a desired degree, the decision may be based on whether processing the current buffer would change the accumulated expansion or compression toward the desired degree even if the result is still in error in the same direction.

### Correlation Processing 214 (FIG. 5)

If it is decided that the current input channel data is to be processed then, as shown in block 214 of FIG. 5, two types of processing may take place, consisting of processing 214-1 and 214-2 of the input signals' time domain information and processing 214-3 and 214-4 of the input signals' phase information. Using the combined phase and time-domain information of the input channel data provides a higher quality time scaling result for signals ranging from speech to complex music than using time-domain information alone. Alternatively, only the time-domain information may be processed if diminished performance is deemed acceptable.

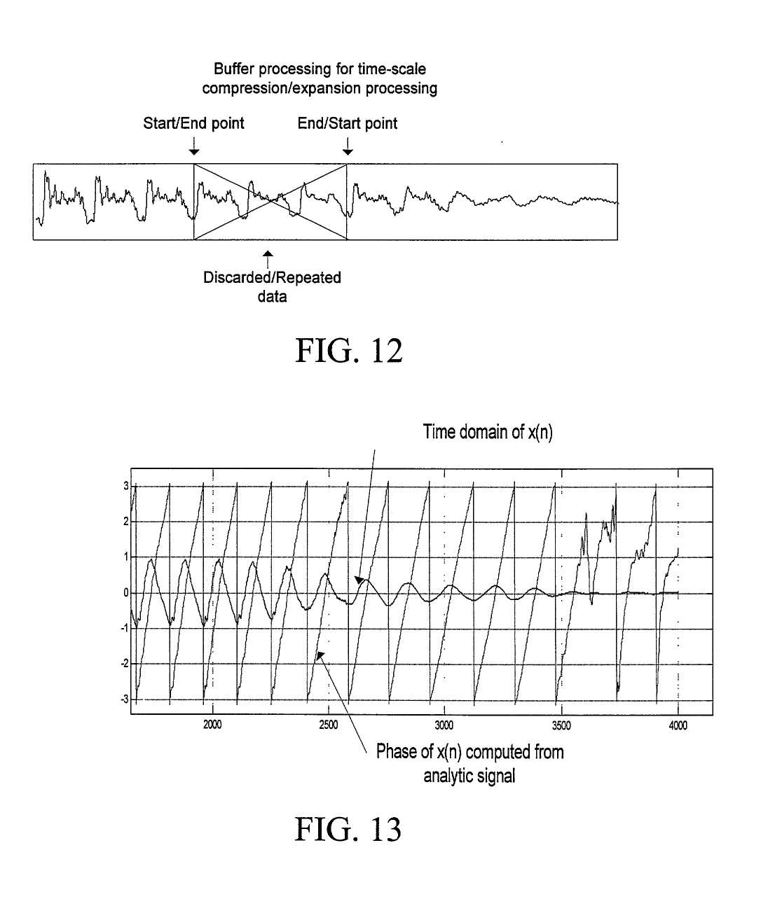

As discussed above and shown in FIGS. 2A-D, the time scaling according to aspects of the present invention works by discarding or repeating segments of the input channel buffers. If the splice and end processing points are chosen such that the data is most similar on either side of these processing points, audible artifacts will be reduced. An example of well-chosen splice and end processing points that maximize the similarity of the data on either side of the discarded or repeated data segment is presented in FIG. 12. The signal shown in FIG. 12 is the time-domain information of a highly periodic portion of a speech signal.

Once a splice point is determined, a method for determining an appropriate end point is needed. In doing so, it is desirable to weight the audio in a manner that has some relationship to human hearing and then perform correlation. The correlation of a signal's time-domain amplitude data provides an easy-to-use estimate of the periodicity of a signal, which is useful in selecting an end point. Although the weighting and correlation can be accomplished in the time domain, it is computationally efficient to do so in the frequency domain. A Fast Fourier Transform (FFT) can be used to compute efficiently an estimate of a signal's power spectrum that is related to the Fourier transform of a signal's correlation. See, for example, Section 12.5 “Correlation and Autocorrelation Using the FFT” in Numerical Recipes in C, The Art of Scientific Computing by William H. Press, et al, Cambridge University Press, New York, 1988, pp. 432-434.

An appropriate end point is determined using the correlation data of the input data buffer's phase and time-domain information. For time compression, the autocorrelation of the audio between the splice and end points is used (see FIG. 2A). The autocorrelation is used because it provides a measure of the periodicity of the data and helps determine how to remove an integer number of cycles of the predominant frequency component of the audio. For time expansion processing the cross correlation of the data before and after the splice point is computed to evaluate the periodicity of the data to be replicated to increase the duration of the audio (see FIG. 2C).

The correlation (autocorrelation for time compression or cross correlation for time expansion, and hereafter referred to as simply correlation) is computed beginning at the splice point and terminating at either the maximum processing length as returned by previous processes or the global maximum processing length (an overall default maximum processing length).

The frequency weighted correlation of the time-domain data may be computed in step 214-1 for each channel. The frequency weighting is done to focus the correlation processing on the most sensitive frequency ranges of human hearing and is in lieu of filtering the time-domain data prior to correlation processing. While a number of different weighted loudness curves are available, one suitable one is a modified B-weighted loudness curve. The modified curve is the standard B-weighted curve computed using the equation:

$$R b ( f ) = \frac{{12200}^{2} * {f}^{3}}{( {f}^{2} + {20.6}^{2} ) ( {f}^{2} + {12200}^{2} ) ( {( {f}^{2} + {158.5}^{2} )}^{0.5} )}$$

with the lower frequency components (approximately 97 Hz and below) set equal to 0.5.

Low-frequency signal components, even though inaudible, when spliced may generate high-frequency artifacts that are audible. Hence, it is desirable to give greater weight to low-frequency components than is given in the standard, unmodified B-weighting curve.

Following weighting, in the process 214-2, the correlation may be computed as follows:

1) form an L-point sequence (a power of 2) by augmenting x(n) with zeros,

2) compute the L point FFT of x(n),

3) multiply the complex FFT result by the conjugate of itself, and

4) compute the L-point inverse FFT.

where x(n) is the digitized time-domain data contained in the input channel data buffer representing the audio samples in the processing region (i.e., between the minimum processing length and the maximum processing length) in which n denotes the sample number and the length L is a power of two greater than the number of samples in that processing.

As mentioned above, weighting and correlation may be efficiently accomplished by multiplying the signals to be correlated in the frequency domain by a weighted loudness curve. In that case, an FFT is applied before weighting and correlation, the weighting is applied during the correlation and then the inverse FFT is applied. Whether done in the time domain or frequency domain, the correlation is then stored for processing by the next step.

As shown in FIG. 5, the instantaneous phase of each input channel data buffer is computed in step 214-3, where the instantaneous phase is defined as

phase(n)=arctan(imag(analytic(x(n))/real(analytic(x(n)))

where x(n) is the digitized time-domain data contained in the input channel data buffer representing the audio samples in the processing region (i.e., between the minimum processing length and the maximum processing length) in which n denotes the sample number.

The function analytic( ) represents the complex analytic version of x(n). The analytic signal can be created by taking the Hilbert transform of x(n) and creating a complex signal where the real part of the signal is x(n) and the imaginary part of the signal is the Hilbert transform of x(n). In this implementation, the analytic signal may be efficiently computed by taking the FFT of the input signal x(n), zeroing out the negative frequency components of the frequency domain signal and then performing the inverse FFT. The result is the complex analytic signal. The phase of x(n) is computed by taking the arctangent of the imaginary part of the analytic signal divided by the real part of the analytic signal. The instantaneous phase of the analytic signal of x(n) is used because it contains important information related to the local behavior of the signal, which helps in the analysis of the periodicity of x(n).

FIG. 13 shows the instantaneous phase of a speech signal, in radians, superimposed over the time-domain signal, x(n). An explanation of “instantaneous phase” is set forth in section 6.4.1 (“Angle Modulated Signals”) in Digital and Analog Communication Systems by K. Sam Shanmugam, John Wiley & Sons, New York 1979, pp. 278-280. By taking into consideration both phase and time domain characteristics, additional information is obtained that enhances the ability to match waveforms at the splice point. Minimizing phase distortion at the splice point tends to reduce undesirable artifacts.

The time-domain signal x(n) is related to the instantaneous phase of the analytic signal of x(n) as follows:

negative going zero crossing of x(n)=+π/2 in phase

positive going zero crossing of x(n)=−π/2 in phase

local max of x(n)=0 in phase

local min of x(n)=±π in phase

These mappings, as well as the intermediate points, provide information that is independent of the amplitude of x(n). Following the calculation of the phase for each channel's data, the correlation of the phase information for each channel is computed in step 214-4 and stored for later processing.

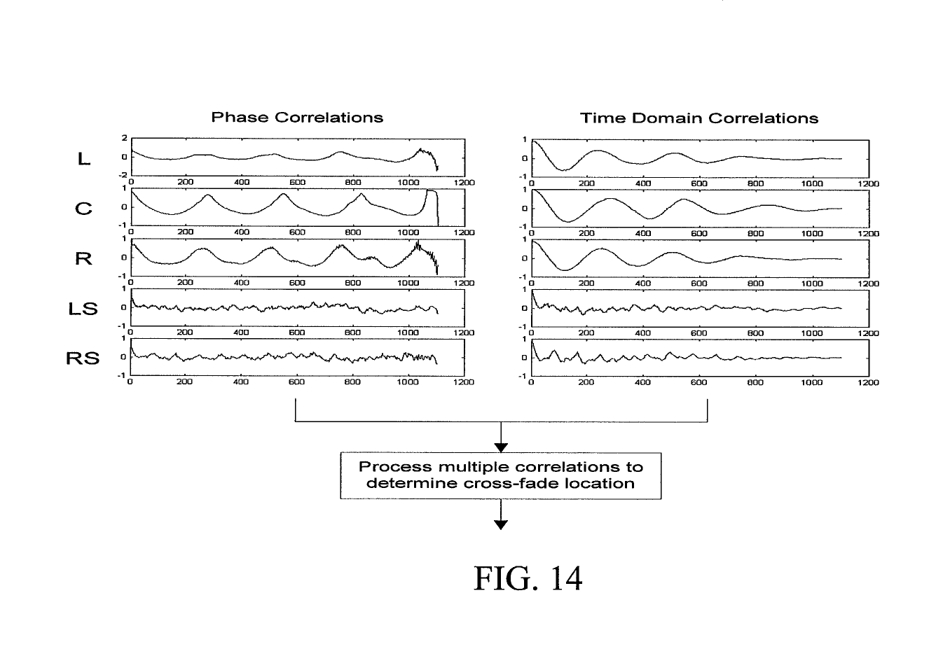

### Multiple Correlation Processing (FIG. 14)

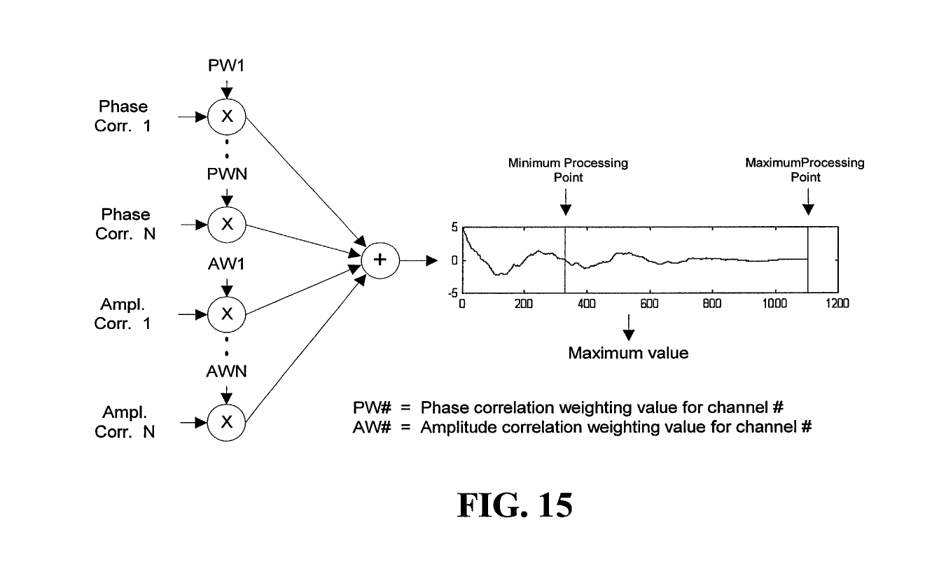

Once the phase and time-domain correlations have been computed for each of the input channels, the correlation-processing step 216 (FIG. 5), as shown in more detail in FIG. 14, processes them. FIG. 14 shows the phase and time-domain correlations for five (Left, Center, Right, Left Surround and Right Surround) input channel data buffers containing music. The correlation processing step, shown conceptually in FIG. 15, accepts the phase and time-domain correlation for each channel as inputs, multiplies each by a weighting value and then sums them to form a single correlation function that represents all inputs of all the input channels' time-domain and phase information. In other words, the FIG. 15 arrangement might be considered a super-correlation function that sums together the ten different correlations to yield a single correlation. The waveform of FIG. 15 shows a maximum correlation value, a desirable end point, at about sample 500, which is between the minimum and maximum splice points. The splice point is at sample 0. The weighting values may be chosen to allow specific channels or correlation type (time-domain versus phase) to have a dominant role in the overall multichannel analysis. The weighting values may also be chosen to be functions of correlation lag that would accentuate signals of certain periodicity over others. A very simple weighting function is a measure of relative loudness among the channels. Such a weighting minimizes the contribution of signals that are so low in level that they may be ignored. Other weighting functions are possible. For example, greater weight may be given to transients. The purpose of the “super correlation” combined weighting of the individual correlations is to seek as good a common end point as possible. Because the multiple channels may be different waveforms, there is no one ideal solution nor is there one ideal technique for seeking a common end point.

The weighted sum of each correlation provides useful insight into the overall periodic nature of all input channels. The resulting overall correlation is searched in the region between the minimum and maximum processing points to determine the maximum value of the correlation. By limiting the area of correlation analysis to between the minimum and maximum processing points, an upper and lower limit on the size of the audio to be deleted or repeated is created. These values also put an upper and lower limit on the percentage of compression or expansion than can be achieved when processing an input data buffer (i.e. the size of the segment of audio that is chosen to be repeated or deleted). A suitable minimum processing value is approximately 7.5 msec.

### Splicing and Crossfade Processing Step

Following the determination of the splice and end points, each channel data buffer is processed by the Splice/Crossfade channel buffer step 218 (FIG. 5). This step accepts each channel's input data buffer, the splice point, the end point and the crossfade.

Referring again to FIG. 9, the input channel data buffer is first windowed at the splice and end processing points using a suitable window. The length of the window is a maximum of 10 msec and may be shorter depending upon the crossfade parameters determined in previous analysis steps. Nonlinear crossfades, as in accordance with a Hanning window, rather than linear crossfades may result in less audible artifacts, particularly for simple single-frequency signals such as tones and tone sweeps. This result is expected given that the Hanning window is continuous and does not inject the spectral noise caused by the “hard knee” of a linear crossfade. While a Hanning window may be used, other windows, such as a Kaiser-Bessel window, may also provide suitable results.

### Pitch Scaling Processing 222 (FIG. 5)

Following the splice/crossfade processing of each input channel data buffer, a decision block 220 (FIG. 5) is checked to determine whether pitch shifting (scaling) is to be performed. As discussed above, time scaling cannot be done in real-time due to buffer underflow or overflow. Pitch scaling can be performed in real-time because of the operation of the resampling step 222. The resampling step resamples the time scaled input signal resulting in a pitch-scaled signal that has the same time evolution or duration as the input signal but with altered spectral information. For real-time implementations, the resampling may be performed with dedicated hardware sample-rate converters to reduce the computation in a DSP implementation. It should be noted that resampling is required only if it is desired to maintain a constant output sampling rate or to maintain the input sampling rate and the output sampling rate the same. In a digital system, a constant output sampling rate or equal input/output sampling rates are normally required. However, if the output of interest were converted to the analog domain, a varying output sampling rate would be of no concern. Thus, resampling is not a necessary part of any of the aspects of the present invention.

Following the pitch scale determination and possible resampling, all processed channel input data buffers are output in step 224 either to file, for non-real time operation, or to an output data buffer for real-time operation. The process flow then checks for additional input data and continues processing.

I claim:

1. A method for time scaling and/or pitch shifting an audio signal, comprising
analyzing said audio signal using multiple psychoacoustic criteria to identify a region of the audio signal in which the omission of a portion of the audio signal or the repetition of a portion of the audio signal is inaudible or minimally audible,
selecting a splice point in said region of the audio signal,
deleting a portion of the audio signal beginning at the splice point or repeating a portion of the audio signal ending at the splice point, and
reading out the resulting audio signal at a rate that yields a desired audio signal time duration and a desired time scaling and/or pitch shifting.

2. A method for time scaling and/or pitch shifting an audio signal represented by samples, comprising
analyzing said audio signal using multiple psychoacoustic criteria to identify a region of the audio signal in which the omission of a portion of the audio signal or the repetition of a portion of the audio signal is inaudible or minimally audible,
selecting a splice point in said region of the audio signal, thereby defining a leading segment of the audio signal that leads the splice point,
selecting an end point spaced from said splice point, thereby defining a trailing segment of the audio signal that trails the endpoint, and a target segment of the audio signal between the splice and end points,
joining said leading and trailing segments at said splice point, thereby decreasing the number of audio signal samples by omitting the target segment when the end point has a higher sample number than said splice point, or increasing the number of samples by repeating the target segment when the end point has a lower sample number than said splice point, and
reading out the joined leading and trailing segments at a rate that yields a desired audio signal time duration and a desired time scaling and/or pitch shifting.

3. The method of claim 2 wherein:
a time duration the same as the original time duration results in pitch shifting the audio signal,
a time duration decreased by the same proportion as the relative change in the reduction in the number of samples, in the case of omitting the target segment, results in time compressing the audio signal,
a time duration increased by the same proportion as the relative change in the increase in the number of samples, in the case of repeating the target segment, results in time expanding the audio signal,
a time duration decreased by a proportion different from the relative change in the reduction in the number of samples results in time compressing and pitch shifting the audio signal, and
a time duration increased by a proportion different from the relative change in the increase in the number of samples results in time expansion and pitch shifting the audio signal.

4. The method of claim 2 wherein the end point is also selected to be in said region.

5. The method of claim 2 wherein analyzing said audio signal using multiple psychoacoustic criteria includes analyzing said audio signal to identify a region of the audio signal in which the audio satisfies at least one criterion of a group of psychoacoustic criteria.

6. The method of claim 5 wherein said psychoacoustic criteria include at least one of the following:
the identified region of said audio signal is substantially premasked or postmasked as the result of a transient,
the identified region of said audio signal is substantially inaudible,
the identified region of said audio signal is predominantly at high frequencies, and
the identified region of said audio signal is a quieter portion of a segment of the audio signal in which a portion or portions of the segment preceding and/or following the region is louder.

7. The method of claim 6 wherein the criterion that the region of said audio is predominantly at high frequencies is based on frequencies above about 10 to 12 kHz.

8. The method of claim 5 wherein said group of psychoacoustic criteria are arranged in order of the increasing audibility of artifacts resulting from the joining of the leading and trailing segments at said splice point.

9. The method of claim 8 wherein said region is identified when the highest ranking psychoacoustic criterion, the criterion leading to the least audible artifacts in said group is satisfied.

10. The method of claim 8 wherein the top-ranked psychoacoustic criterion is that the region of said audio signal is substantially premasked or masked as the result of a transient.

11. The method of claim 8 wherein said psychoacoustic criteria include at least the following four criteria, ranked in the following order:
the identified region of said audio signal is substantially premasked or postmasked as the result of a transient,
the identified region of said audio signal is substantially inaudible,
the identified region of said audio signal is predominantly at high frequencies, and
the identified region of said audio signal is a quieter portion of a segment of the audio signal in which a portion or portions of the segment preceding and/or following the region is louder.

12. The method of claim 11 wherein the criterion that the region of said audio is predominantly at high frequencies is based on frequencies above about 10 to 12 kHz.

13. The method of claim 5 wherein the end point is also selected to be in said region.

14. The method of any one of claim 2 wherein said step of joining said leading and trailing segments at the splice point includes crossfading the leading and trailing segments.

15. The method of claim 14 wherein the crossfading is a linear crossfading.

16. The method of claim 14 wherein the crossfading is a nonlinear crossfading.

17. The method of claim 16 wherein the nonlinear crossfading is in accordance with a Hanning window.

18. The method of claim 16 wherein the nonlinear crossfading is in accordance with a Kaiser-Bessel window.

19. The method of claim 14 wherein the length of the crossfade resulting from crossfading the leading and trailing segments is variable.

20. The method of claim 19 wherein the length of the crossfade resulting from crossfading the leading and trailing segments is selected to minimize audible splicing artifacts.

21. The method of claim 19 wherein the crossfading is a linear crossfading.

22. The method of claim 19 wherein the crossfading is a nonlinear crossfading.

23. The method of claim 22 wherein the nonlinear crossfading is in accordance with a Hanning window.

24. The method of claim 22 wherein the nonlinear crossfading is in accordance with a Kaiser-Bessel window.

25. The method of claim 2, wherein in the case of decreasing the number of audio signal samples by omitting the target segment, said end point is selected by auto correlating a segment of audio trailing the splice point.

26. The method of claim 25 wherein said end point is selected by auto correlating a segment of audio trailing the sample point up to a maximum processing point and selecting an end point substantially at the point of maximum autocorrelation that is greater than a minimum processing point.

27. The method of claim 26 wherein said maximum processing point is fixed relative to said splice point.

28. The method of claim 26 wherein said minimum processing point is variable relative to said splice point.

29. The method of claim 28 wherein said minimum processing point is variable relative to said splice point in response to signal characteristics near said splice point.

30. The method of claim 25 wherein said autocorrelation is based on the time-domain characteristics of the audio signal.

31. The method of claim 30 wherein the time domain characteristics of the audio signal are weighted according to human hearing sensitivity.

32. The method of claim 25 wherein said autocorrelation is based on the phase characteristics of the audio signal.

33. The method of claim 32 wherein said autocorrelation is based on the instantaneous phase characteristics of the audio signal.

34. The method of claim 25 wherein said autocorrelation is based on the phase and time-domain characteristics of the audio signal.

35. The method of claim 34 wherein the time domain characteristics of the audio signal are weighted according to human hearing sensitivity.

36. The method of claim 34 wherein said autocorrelation is based on the instantaneous phase and time-domain characteristics of the audio signal.

37. The method of claim 36 wherein the time domain characteristics of the audio signal are weighted according to human hearing sensitivity.

38. The method of claim 2, wherein in the case of increasing the number of audio signal samples by repeating the target segment, said end point is selected by cross correlating segments of audio leading and trailing the splice point.

39. The method of claim 38 wherein said end point is selected by cross correlating a segment of audio leading the splice point up to a first maximum processing point and a segment of audio trailing the splice point up to a second maximum processing point and selecting an end point in the segment leading the splice point substantially at the point of maximum cross correlation that is greater than a minimum processing point.

40. The method of claim 39 wherein said first and second maximum processing points are fixed relative to said splice point.

41. The method of claim 40 wherein said first and second maximum processing points are the same relative to said splice point.

42. The method of claim 39 wherein said minimum processing point is variable relative to said splice point.

43. The method of claim 42 wherein said minimum processing point is variable relative to said splice point in response to signal characteristics near said splice point.

44. The method of claim 38 wherein said cross correlation is based on the time-domain characteristics of the audio signal.

45. The method of claim 44, wherein the time domain characteristics of the audio signal are weighted according to human hearing sensitivity.

46. The method of claim 38 wherein said autocorrelation is based on the phase characteristics of the audio signal.

47. The method of claim 46 wherein said autocorrelation is based on the instantaneous phase characteristics of the audio signal.

48. The method of claim 38 wherein said autocorrelation is based on the phase and time-domain characteristics of the audio signal.

49. The method of claim 48, wherein the time domain characteristics of the audio signal are weighted according to human hearing sensitivity.

50. The method of claim 48 wherein said autocorrelation is based on the instantaneous phase and time-domain characteristics of the audio signal.

51. The method of claim 50, wherein the time domain characteristics of the audio signal are weighted according to human hearing sensitivity.

52. A method for time scaling and/or pitch shifting multiple channels of audio signals, comprising
analyzing each of said audio signals using at least one psychoacoustic criterion to identify at least one region in each of the audio signals in which the omission of a portion of the audio signal or the repetition of a portion of the audio signal is inaudible or minimally audible,
selecting a common splice point in one of said regions in each of the audio signals, wherein the splice points in the multiple channels of audio signals are selected to be substantially aligned with one another,
deleting a portion of each audio signal beginning at the common splice point or repeating a portion of the audio signal ending at the common splice point, and
reading out the resulting audio signals at a rate that yields a desired time duration for the multiple channels of audio and a desired time scaling and/or pitch shifting for the multiple channels of audio.

53. A method for time scaling and/or pitch shifting multiple channels of audio signals, each signal represented by samples, comprising
analyzing each of said audio signals using at least one psychoacoustic criterion to identify at least one region in each of the audio signals in which the omission of a portion of the audio signal or the repetition of a portion of the audio signal is inaudible or minimally audible,
selecting a common splice point in one of said regions in each of the audio signals, thereby defining a leading segment of the audio signal that leads the splice point, wherein the splice points in the multiple channels of audio signals are selected to be substantially aligned with one another,
selecting an end point spaced from said splice point in each of the audio signals, thereby defining a trailing segment of the audio signal trailing the endpoint and a target segment of the audio signal between the splice and end points, wherein the end points in the multiple channels of audio signals are selected to be substantially aligned with one another,
joining said leading and trailing segments at said splice point in each of the audio signals, thereby decreasing the number of audio signal samples by omitting the target segment when the end point has a higher sample number than said splice point, or increasing the number of samples by repeating the target segment when the end point has a lower sample number than said splice point, and
reading out the joined leading and trailing segments in each of the audio signals at a rate that yields a desired time duration for the multiple channels of audio and a desired time scaling and/or pitch shifting for the multiple channels of audio.

54. The method of claim 53, wherein:
a time duration the same as the original time duration results in pitch shifting the audio signals,
a time duration decreased by the same proportion as the relative change in the reduction in the number of samples, in the case of omitting the target segment, results in time compressing the audio signals,
a time duration increased by the same proportion as the relative change in the increase in the number of samples, in the case of repeating the target segment, results in time expanding the audio signals,
a time duration decreased by a proportion different from the relative change in the reduction in the number of samples results in time compressing and pitch shifting the audio signals, and
a time duration increased by a proportion different from the relative change in the increase in the number of samples results in time expansion and pitch shifting the audio signals.

55. The method of claim 53 wherein said selecting a common splice point selects a splice point in each of said audio signals, one or more of which splice points may not not be coincident with one or more other splice points, and selects one of said splice points as the common splice point.

56. The method of claim 55 wherein said selecting a common splice point selects a common splice point from among said splice points using the psychoacoustic criteria employed to identify said regions.

57. The method of claim 56 wherein said selecting a common splice point selects a common splice point from among said splice points by also taking into account cross-channel effects using at least one psychoacoustic criterion.

58. The method of claim 53 wherein said selecting a common splice point identifies portions of said audio signals in which identified regions overlap, and selects a common splice point in the overlapping portion of said identified regions.

59. The method of claim 58 wherein said selecting a common splice point selects a common splice point in the overlapping portion of said identified regions using the psychoacoustic criteria employed to identify said regions.

60. The method of claim 58 wherein said selecting a common splice point selects a common splice point in the overlapping portion of said identified regions by also taking into account cross-channel effects using at least one psychoacoustic criterion.

61. The method of claim 3 wherein said selecting a common splice point selects a common splice point using the psychoacoustic criteria employed to identify said regions.

62. The method of claim 61 wherein said selecting a common splice point selects a common splice point by also taking into account cross-channel effects using at least one psychoacoustic criterion.

63. The method of claim 53 wherein the end point is also selected to be in said region in each of the audio signals.

64. The method of claim 53 wherein analyzing said audio signal using at least one psychoacoustic criterion to identify at least one region in each of the audio signals in which the omission of a portion of the audio signal or the repetition of a portion of the audio signal is inaudible or minimally audible includes analyzing said audio signal to identify a region of the audio signal in which the audio satisfies at least one criterion of a group of psychoacoustic criteria.

65. The method of claim 64 wherein said psychoacoustic criteria include at least one of the following:
the identified region of said audio signal is substantially premasked or postmasked as the result of a transient,
the identified region of said audio signal is substantially inaudible,
the identified region of said audio signal is predominantly at high frequencies, and
the identified region of said audio signal is a quieter portion of a segment of the audio signal in which a portion or portions of the segment preceding and/or following the region is louder.

66. The method of claim 65 wherein the criterion that the region of said audio is predominantly at high frequencies is based on frequencies above about 10 to 12 kHz.

67. The method of claim 64 wherein said group of psychoacoustic criteria are arranged in order of the increasing audibility of artifacts resulting from the joining of the leading and trailing segments at said splice point.

68. The method of claim 67 wherein said region is identified when the highest-ranking psychoacoustic, the criterion leading to the least audible artifacts in said group is satisfied.

69. The method of claim 67 wherein the top-ranked psychoacoustic criterion is that the region of said audio signal is substantially premasked or masked as the result of a transient.

70. The method of claim 67 wherein said psychoacoustic criteria include at least the following four criteria, ranked in the following order:
the identified region of said audio signal is substantially premasked or postmasked as the result of a transient,
the identified region of said audio signal is substantially inaudible,
the identified region of said audio signal is predominantly at high frequencies, and
the identified region of said audio signal is a quieter portion of a segment of the audio signal in which a portion or portions of the segment preceding and/or following the region is louder.

71. The method of claim 70 wherein the criterion that the region of said audio is predominantly at high frequencies is based on frequencies above about 10 to 12 kHz.

72. The method of claim 64 wherein the end point is also selected to be in said region.
